(19) United States
(12) Patent Application Publication
(10) Pub. No.: US 2010/0040757 A1
(43) Pub. Date: Feb. 18, 2010

(54) Health Beverage and Additive Mixture for Preparing the Same

(76) Inventor: Dorcas Chin, Point Pleasant, NJ (US)

Correspondence Address: Brandon L. Underwood, LLC, 44 Princeton Avenue, Brick, NJ, 08724, US

(21) Appl. No.: 12/605,334

(22) Filed: Oct. 24, 2009

Related U.S. Application Data
(63) Continuation-in-part of application No. 12/248,037, filed on Oct. 8, 2008.
Application No. 12/248,037 is a continuation-in-part of application No. 12/017,042, filed on Jan. 20, 2008, now abandoned.

(51) Int. Cl. A23F 5/00

(52) U.S. Cl. 426/594

(57) ABSTRACT

A beverage includes a liquid base, a coffee component, a saccharide component, a ginseng component, and a protein component. Per 8 ounces of the liquid base, the coffee component comprises between about 0.75 grams to about 12.65 grams, the saccharide component comprises between about 2.4 grams to about 23 grams, the ginseng component comprises between about 0.1 grams to about 0.6 grams, and the protein component comprises between about 1.24 grams to about 42.745 grams.

### CROSS REFERENCE TO RELATED APPLICATIONS

This application is a continuation in part of application Ser. No. 12/248,037, filed Oct. 8, 2008, which application is currently pending.

Application Ser. No. 12/248,037 is a continuation in part of parent application Ser. No. 12/017,042, filed Jan. 20, 2008, which parent application is now abandoned.

### FIELD

Various embodiments generally relate to a beverage, or more particularly, a health beverage.

### BACKGROUND

Coffee is a beverage available in many varieties, including many that contain caffeine. Caffeine has been known to enhance intellectual performance and memory, as well as speed up metabolism while conserving glycogen and glucose. But, caffeine also has many undesirable side effects in the human body, including irritation of the stomach lining leading to interference with adenosine (a normally calming brain chemical), increased stress, and interference with proper levels of cholesterol.

Ginseng is an herb that is utilized for therapeutic purposes in many parts of the world. But, ginseng's potent flavor makes it unpalatable to many individuals, and is difficult to mask. Although the health benefits of ginseng have been targeted for exploitation in beverages (including coffee beverages), there has been no attempt to strike an optimum balance of elements to maximize the overall health benefits and palatability of the composition. Moreover, compositions utilizing ginseng and coffee have been implemented in a manner that may be harmful to the body. As an example, some compositions have sought to maximize stimulating effects of ginseng and caffeine, but disregard the negative effects of the caffeine on the body. Other attempts have sought to improve the caffeine taste, but not the taste of the herb. Such attempts have included the addition of refined sugars, artificial sweeteners, and partially hydrogenated oils, which have been known to increase acidity and stress on the body. The addition of these elements and the like counter the beneficial effects of a caffeine and herb combination, and may among other potentially harmful effects introduce digestibility and obesity issues, as well as require the body to use more energy to assimilate the beverage.

### SUMMARY

In various embodiments, a beverage includes a liquid base, a coffee component, a saccharide component, a ginseng component, and a protein component. In one exemplary embodiment, per 8 ounces of the liquid base, the coffee component comprises between about 0.75 grams to about 12.65 grams, the saccharide component comprises between about 2.4 grams to about 23 grams, the ginseng component comprises between about 0.1 grams to about 0.6 grams, and the protein component comprises between about 1.24 grams to about 42.75 grams.

In other embodiments, an additive mixture for combining with with a liquid base to prepare a beverage includes a coffee component, a ginseng component, a saccharide component, and a protein component. In one exemplary embodiment, a unit amount of the additive mixture comprises between about 0.75 grams to about 12.65 grams of the coffee component, between about 2.4 grams to about 23 grams of the saccharide component, between about 0.1 grams to about 0.6 grams of the ginseng component, and between about 1.24 grams to about 42.75 grams of the protein component.

### DETAILED DESCRIPTION

In various embodiments, a beverage includes a liquid base, a coffee component, a saccharide component, ginseng component, and a protein component. The components are combined in proportions providing an optimized balance of health enhancing benefits and palatability to the beverage. Specifically, the components are combined in a manner that mitigates undesirable taste(s) associated with at least the herbal component and/or caffeine in the coffee component, while maximizing effectiveness of the herbal component. In one embodiment, cocoa is added to the beverage to further optimize health benefits and palatability, while vanilla is added for the same purposes in another. In yet another embodiment, a pH raising component is added to provide a healthy pH level.

In one embodiment, the liquid base comprises water. For health benefits, it is preferred (but not necessary) that the water be purified or distilled . The beverage comprises about 0.75 grams to about 12.65 grams of coffee component per eight ounces of the water. However, it is also contemplated that other and further amounts of the coffee component may be included, without departing from the basic scope. The coffee component comprises at least one of brewed coffee, instant coffee granules, or mixtures thereof. The coffee component may also include espresso and/or cappuccino with a suitable amount of milk or other liquids common to espresso and/or cappuccino provided either wholly as, or in addition to water in the liquid component. The coffee component may also comprise a flavored coffee variety. The coffee component may be caffeinated, decaffeinated, or mixtures thereof.

In various embodiments, the ginseng component comprises ginseng with a saccharide additionally bonded thereto. The saccharide additionally bonded to the ginseng is entirely associated with the ginseng component, not the previously mentioned “saccharide component,”which is added to the beverage as a separate element and will be described in more detail below.

In one embodiment, the ginseng comprises at least one of American Ginseng (Panax Quinquefolius), Korean (Panax) Ginseng, or mixtures thereof. These two types of ginseng are selected, among other reasons, because of their physical qualities and health benefits. Specifically, the roots of Panax Ginseng and Panax Quinquefolius Ginseng contain several ginsenosides that have been known to stimulate and enhance the human mind and physical performance. Positive effects obtained therefrom include but are not limited to stimulation of the pituitary and adrenal glands (which increases the body's resistance to harmful stresses) and stimulation of the nervous system (which improves ability to think analytically, diminishes fatigue, and relieves tension). Further beneficial effects include reduction of blood sugar and cholesterol, increased sexual function, and an anti-diuretic effect. It is also contemplated, however, that other and further types of ginseng(s) besides Panax Quinquefolius Ginseng and/or Panax Ginseng may be utilized as the ginseng component, without departing from the basic scope. Such Ginseng components may include (but are not limited to) Siberian Ginseng, Ginseng extracts and/or any other suitable Ginseng variety or combinations thereof.

In various embodiments, a beverage includes between about 0.1 grams to about 0.6 grams of the ginseng component per 8 ounces of the liquid base. However, it is also contemplated that other and further amounts of the ginseng component may be included, without departing from the basic scope. Ginseng, when added in the previously mentioned amounts to the liquid base and coffee component, yields an increased effect of the herb while decreasing detrimental effects of caffeine in the coffee component, and provides a desirable taste to the beverage. The taste of the ginseng may disappear at about 0.3 grams per 8 ounces of the liquid base when the liquid base (as an example) is water, but therapeutic effects of the ginseng will remain with as little as about 0.1 grams when the beverage is consumed on a regular basis (e.g. every day). In one embodiment, the ginseng component is in the form of granules, wherein the saccharide additionally bonded thereto may include glucose or another suitable saccharide. The granules comprise by weight about 90 percent saccharide and about 10 percent ginseng. The saccharide aids in the dissolution of the ginseng, as well as provides a sweetness to the beverage to improve taste.

In one embodiment, a separate saccharide component is added to the beverage at about 2.4 grams to about 23 grams per 8 ounces of the liquid base. However, it is also contemplated that other and further amounts of the saccharide component may be included, without departing from the basic scope. As mentioned, the separate “saccharide component” is not the saccharide additionally bonded to the ginseng of the ginseng component, but an individually added element. In one embodiment, the separate saccharide component is glucose. Glucose dissolves well in a liquid base and is the simplest form of sugar for human assimilation. The human body converts all sugar types to glucose prior to absorption into the blood stream. Other suitable saccharides include honey, lactose, agave nectar, Inulin, luo han guo, organic cane sugar, fructose, and sucrose, as examples. Although natural saccharides are preferred in order to maintain overall health benefits of the beverage, it is also contemplated that other and further saccharide types beyond those provided above as examples may also be utilized, to include any suitable natural or manufactured variety of saccharides, or saccharide derivatives, without departing from the basic scope.

In various embodiments, a beverage also includes a protein component at about 1.24 grams to about 42.745 grams per 8 ounces of the liquid component. However, it is also contemplated that other and further amounts of the protein component may be included, without departing from the basic scope. In one embodiment, the protein component comprises whey protein. Whey protein is selected because of its digestibility, protein value, and superior absorption properties. In another embodiment, soy protein (e.g. soymilk) is utilized. Soy protein is utilized in various embodiments because it is cholesterol free and includes phytochemicals, which have antioxident properties. The soy protein may also include soy lecithin (e.g., as a fatty acid to combine with the soy protein to aid in the assimilation of the soy protein), or other suitable additives typical to soy protein, without departing from the basic scope. In yet another embodiment, the protein component comprises coconut milk. The coconut milk may be included in either a liquid form, a powder form, or combinations thereof. Coconut milk is used in various embodiments for both its flavor properties and oil. While pure coconut milk and/or coconut milk powder is preferred, coconut milk extract and or coconut milk products containing additives such as (but not limited to) guar gum may also be utilized without departing from the basic scope.

Coconut oil provides several health benefits not found in other dietary fats or oils. Among those benefits, are that coconut oil is compose of medium chain fatty acids MCFA, as opposed to animal fats and vegetable oils, which are composed almost entirely of long chain fatty acids LCFA. LCFA's, and if not burned immediately for energy, are circulated and stored by the body as fat. The body metabolizes MCFA's differently than LCFA's by producing energy immediately. Additionally, the MCFA's are digested more easily (than LCFA's) by the saliva and stomach, which relieves stress on both the pancreas and digestive system.

While whey, soy and coconut milk proteins are specifically desired for inclusion as or in the protein component in various embodiments, dairy products (e.g. milk, cream, half-and-half, etc.) may also be utilized without departing from the basic scope. However, dairy products might not be suitable for all embodiments, for reasons including dairy products' mucous forming properties, and their being a common allergen to many individuals. It is however contemplated that the protein component may include other and further protein sources beyond those previously mentioned, without departing from the basic scope. It is fully envisioned that any suitable protein source may be utilized, befitting of the embodiment being implemented.

In various embodiments, the beverage includes vanilla at an amount of about 0.05 grams to about 0.79 grams per 8 ounces of the liquid beverage to enhance flavor. Cocoa is further added at about 1.1 grams to about 14.23 grams per 8 ounces of the liquid component. However, it is also contemplated that other and further amounts of the cocoa and vanilla may be included, without departing from the basic scope. Cocoa, in addition to enhancing flavor, is also an antioxidant. To maintain health benefits of the beverage, it is preferred (but not necessary) that both the vanilla and cocoa be organic.

In various embodiments, an electrolyte component is further included in the beverage. In one embodiment, the electrolyte component includes salt. In addition to being desired for its electrolyte properties, salt is also utilized for its flavor qualities. Among other benefits, the electrolyte properties of the salt helps maintain body fluids that would be lost at a higher rate via increased urination stimulated by caffeine (where applicable) in the coffee component. In one embodiment, the salt comprises sea salt. Sea salt is utilized (among other reasons) for its flavor properties and mineral content. Yet, it is also contemplated that any suitable electrolyte component, not just salt, may be utilized without departing from the basic scope. In one embodiment, the electrolyte component (e.g., salt and/or sea salt) is added to the beverage at about 18 milligrams to about 150 milligrams per 8 ounces of the liquid base. But, it is also contemplated that other and further amounts of the electrolyte component may be included, without departing from the basic scope.

In various embodiments, a beverage further includes peppermint. The peppermint may be in the form of an oil, powder, extract or any other suitable form(s) or combination thereof. Peppermint may aid in reducing the discomfort associated with indigestion, respiratory problems, bowl spasms and pain. It also contains numerous minerals and nutrients, including maganese, iron, magnesium, folate, potassium and copper, as well as Omega-3 fatty acids, Vitamin A and Vitamin C. However, peppermint has a very strong taste, making it difficult to use and requiring that it be carefully balanced with other ingredients in a beverage to maintain palatability. In one embodiment, a beverage includes peppermint at a respective volume of between about 0.05 milliliters to about 0.3 milliliters, per 8 ounces of a liquid base. Yet, it is also contemplated that other and further amounts of peppermint may also be added to the beverage, to include any suitable amount thereof, without departing from the basic scope.

In various embodiments, a pH raising component is also included in the beverage in a sufficient quantity to set the pH thereof to a desired level. In one embodiment the pH is is set to between about 6.5 to about 7.5. The pH raising component may comprise at least one of tricalcium phosphate, calcium carbonate, or a mixture thereof.

In one embodiment, a pH leveling component may comprise between about 0.4 percent to about 1.3 percent by weight of an additive mixture (coffee component, saccharide component, ginseng component, protein component, etc) added to a liquid base to comprise a beverage. But other and further amounts of the pH leveling component may also be added, without departing from the basic scope. The pH raising component may additionally serve as an anti-caking agent.

The acid-alkaline balance in the body is very important to maintaining proper body function and overall health. It is preferred that the beverage have an overall basic pH. A basic pH aids in preventing break down of the human joints, which has been known to occur when the body is acidified. Coffee is innately acidic, giving it a low pH value (e.g. 4.9 to 5.2). Ginseng bound with glucose will yield a pH of about 6.4, which is the approximate pH of some bottled waters. In an exemplary embodiment wherein water comprises the liquid base, the liquid base has a pH of between 8.5 to 9.5, yielding an overall pH to the beverage of approximately 7.2.

It will be appreciated by those skilled in the art and informed by the teachings herein, however, that the pH values of water can vary widely (e.g. tap vs. purified, etc.), as can pH values of the plurality other liquid bases it is envisioned can be utilized. The initial pH of a beverage can also vary depending upon the different ranges of ingredients added to the liquid component. Therefore, the amount of pH raising component utilized for each respective embodiment will vary commensurately.

Accordingly, those skilled in the art and informed by the teachings herein will realize that a suitable means for obtaining a desired pH may include (but is not limited to): preparing a small batch of the beverage (e.g. 8 ounces) utilizing previously explained proportions of components, initially excluding a pH raising component; testing an initial pH of the beverage without the pH raising component; and iteratively adding a small amount of pH raising component and testing the resultant pH therefrom until a desired pH (e.g. of between about 6.5 to about 7.5) is reached. The value of pH raising component sufficient to achieve a desired pH in the small batch of beverage may then be scaled according to whatever overall amount (i.e. multiple of the small batch) of the beverage is to be prepared.

In various embodiments, an additive mixture for combining with with a liquid base to prepare a beverage utilizing the components and proportions thereof as previously described, includes a coffee component, a ginseng component, a saccharide component, and a protein component. In one exemplary embodiment, a unit amount of the additive mixture comprises between about 0.75 grams to about 12.65 grams of the coffee component, between about 2.4 grams to about 23 grams of the saccharide component, between about 0.1 grams to about 0.6 grams of the ginseng component, and between about 1.24 grams to about 42.745 grams of the protein component. The unit amount may be scaled by any amount to make any desired quantity of the additive mixture.

In other exemplary embodiments, a unit amount of the additive mixture may also include vanilla at about 0.05 grams to about 0.79 grams, cocoa at about 1.1 grams to about 14.23 grams, and/or an electrolyte component at about 18 milligrams to about 150 milligrams by weight, and peppermint at about 0.05 milliliters to about 0.3 milliliters by volume. The additive mixture is suitable for diluting in a liquid base (e.g. water) in sufficient amount to make a beverage of any desired strength. Based on proportions described above with respect to a complete beverage (i.e. including a liquid base), this may in one exemplary embodiment include between about 5.7 grams to about 94.2 grams of the additive mixture, per 8 ounces of a liquid base that the additive mixture would be combined with. A specific amount of additive mixture to be added to a liquid base may be specified to an end-user (e.g. customer) preparing a beverage from the mixture, as well as a suitable liquid base to utilize. In one embodiment, a specified liquid base may include water. Those skilled in the art and informed by the teachings herein will appreciate that a means of preparing a beverage with the additive mixture includes combining the additive mixture with a liquid base and agitating (e.g. mixing) the two.

In one embodiment, a pH raising component may also be included in the mixture, with the amount of pH raising component determined in view of a specified (e.g. to a customer) amount of the additive mixture to be combined with a liquid base to prepare a beverage. As with various embodiments previously described with respect to a complete beverage (i.e. including a liquid base), in an exemplary embodiment of the additive mixture, the pH raising component is provided in sufficient quantity to set the pH of a beverage prepared with the additive mixture to a value of between about 6.5 to about 7.5. In one embodiment, a pH leveling component may comprise between about 0.4 percent to about 1.3 percent by weight of an additive mixture.

It will be appreciated by those skilled in the art and informed by the teachings herein that as with embodiments previously discussed with respect to a beverage, an amount of pH raising component for an additive mixture may be determined by similar means. For the additive mixture, those means may include (but are not limited to): preparing a small batch of a beverage (e.g. 8 ounces) utilizing a specified amount of the additive mixture, initially excluding a pH raising component; testing the initial pH of the prepared beverage without the pH raising component; and iteratively adding a small amount of pH raising component to the prepared beverage and testing the resultant pH therefrom, until a desired pH (e.g. of between about 6.5 to about 7.5) is reached. The proportional amount pH raising component with respect to the overall weight of the additive mixture required to be appended to reach the desired pH may then be added to the additive mixture in that same proportion for any amount of the additive mixture to be manufactured. Thereafter, a proper amount of additive mixture to be combined with a given amount/type of liquid base to prepare a beverage of the desired pH may subsequently be specified.

Due to the health promoting benefits of the various embodiments of a beverage and additive mixture described herein, it is preferred that they be prepared utilizing all natural and/or organic ingredients whenever possible/practical. However, it is also contemplated that non-organic ingredients, including artificial flavorings, can be utilized/substituted entirely or in any proportion, without departing from the basic scope.

It will be appreciated by those skilled in the art that all previously described embodiments are merely illustrative applications of the principles of the invention. Accordingly, reference herein to details of any exemplary embodiment(s) is not intended to limit the scope of the claims, which themselves recite those features regarded as essential to the invention.

What is claimed is:

1. A beverage, comprising:
a liquid base;
a coffee component;
a saccharide component;
a ginseng component; and
a protein component;

2. The beverage of claim 1, wherein per 8 ounces of the liquid base, the coffee component comprises between about 0.75 grams to about 12.65 grams, the saccharide component comprises between about 2.4 grams to about 23 grams, the ginseng component comprises between about 0.1 grams to about 0.6 grams, and the protein component comprises between about 1.24 grams to about 42.745 grams.

3. The beverage of claim 1, further comprising vanilla.

4. The beverage of claim 1, further comprising cocoa.

5. The beverage of claim 1, further comprising a pH raising component.

6. The beverage of claim 1, wherein the saccharide component comprises at least one of glucose, lactose, agave nectar, Inulin, luo han guo, honey, organic cane sugar, fructose, sucrose, or mixtures thereof.

7. The beverage of claim 1, wherein the ginseng component comprises at least one of Panax Ginseng with an additional saccharide bonded thereto, Panax Quinquefolius Ginseng with an additional saccharide bonded thereto, Siberian Ginseng with an additional Saccharide bonded thereto, or mixtures thereof.

8. The beverage of claim 1, wherein the protein component comprises at least one of whey protein, soy protein, or mixtures thereof.

9. The beverage of claim 5, wherein the pH raising component comprises at least one of tricalcium phosphate, calcium carbonate, or mixtures thereof.

10. The beverage of claim 3, wherein per 8 ounces of the liquid base, the vanilla comprises between about 0.05 grams to about 0.79 grams.

11. The beverage of claim 4, wherein per 8 ounces of the liquid base, the cocoa comprises between about 1.1 grams to about 14.23 grams.

12. The beverage of claim 1, wherein the coffee component comprises at least one of ground coffee beans brewed in the liquid base, instant coffee granules, or mixtures thereof.

13. The beverage of claim 1, wherein the liquid base comprises water.

14. The beverage of claim 1, further comprising an electrolyte component.

15. The beverage of claim 14, wherein the electrolyte component comprises sea salt.

16. The beverage of claim 15, wherein per 8 ounces of the liquid base, the sea salt comprises between about 18 milligrams to about 150 milligrams.

17. An additive mixture for combining with a liquid base to make a beverage, comprising:
a coffee component;
a ginseng component;
a saccharide component; and
a protein component.

18. The additive mixture of claim 17, wherein a unit amount of the additive mixture comprises between about 0.75 grams to about 12.65 grams of the coffee component, between about 2.4 grams to about 23 grams of the saccharide component, between about 0.1 grams to about 0.6 grams of the ginseng component, and between about 1.24 grams to about 42.745 grams of the protein component.

19. The additive mixture of claim 17, further comprising vanilla.

20. The additive mixture of claim 17, further comprising cocoa.

21. The additive mixture of claim 17, further comprising a pH raising component.

22. The additive mixture of claim 17, wherein the saccharide component comprises at least one of glucose, lactose, agave nectar, Inulin, luo han guo, honey, organic cane sugar, fructose, sucrose, or mixtures thereof.

23. The additive mixture of claim 17, wherein the ginseng component comprises at least one of Panax Ginseng with an additional saccharide bonded thereto, Panax Quinquefolius Ginseng with an additional saccharide bonded thereto, Siberian Ginseng with an additional Saccharide bonded thereto, or mixtures thereof.

24. The additive of claim 17, wherein the protein component comprises at least one of whey protein, soy protein, or mixtures thereof.

25. The additive mixture of claim 21, wherein the pH raising component comprises at least one of tricalcium phosphate, calcium carbonate, or mixtures thereof.

26. The additive mixture of claim 19, wherein a unit amount of the additive mixture comprises between about 0.05 grams to about 0.79 grams of the vanilla.

27. The additive of claim 20, wherein a unit amount of the additive mixture comprises between about 1.1 grams to about 14.23 grams of the cocoa.

28. The additive mixture of claim 17, wherein the coffee component comprises instant coffee granules.

29. The additive mixture of claim 17, further comprising an electrolyte component.

30. The additive mixture of claim 17, further comprising peppermint.

31. The additive mixture of claim 30 wherein a unit amount of the additive mixture comprises between about 0.05 milliliters to about 0.3 milliliters of the peppermint.

32. The beverage of claim 1, further comprising peppermint.

33. The beverage of claim 32, wherein per 8 ounces of the liquid base, the peppermint comprises between about 0.05 milliliters to about 0.3 milliliters.
